(19) United States
(12) Patent Application Publication
(10) Pub. No.: US 2009/0024411 A1
(43) Pub. Date: Jan. 22, 2009

(54) SYSTEM AND METHOD FOR CONTEXTUALIZING PATIENT HEALTH INFORMATION IN ELECTRONIC HEALTH RECORDS

(76) Inventors: Thomas W. Albro, Seattle, WA (US); Jonathan B. Solomon, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 12/102,863

(22) Filed: Apr. 14, 2008

Related U.S. Application Data
(60) Provisional application No. 60/911,502, filed on Apr. 12, 2007.

(51) Int. Cl. G06Q 10/00; G10L 15/26

(52) U.S. Cl. 705/2; 704/235

(57) ABSTRACT

System and method for contextualizing input and presentation of patient information in Electronic Health Record systems. The system and method enhance the ease of use and usefulness of Electronic Health Record systems, and are configurable to capture and automatically integrate dictated and transcribed free-form text into an Electronic Health Record (“EHR”) and present discrete health data maintained in an EHR to system users in an interactive, contextualized, and annotated graphical form.

### PRIORITY CLAIM

This application claims priority from earlier filed U.S. Provisional Patent Application Ser. No. 60/911,502 filed Apr. 12, 2007. The foregoing application is hereby incorporated by reference in its entirety as if fully set forth herein.

This disclosure is protected under United States and International Copyright Laws.© 2007-2008 PRO-SCRIBE, INC. All Rights Reserved. A portion of the disclosure of this patent document contains material which is subject to copyright protection. The copyright owner has no objection to the facsimile reproduction by anyone of the patent document or the patent disclosure after formal publication by the USPTO, as it appears in the Patent and Trademark Office patent file or records, but otherwise reserves all copyright rights whatsoever.

### FIELD OF THE INVENTION

This invention relates generally to systems and methods for improving the ease of use and usefulness of Electronic Health Record systems by providing context for input and presented information.

### BACKGROUND OF THE INVENTION

Digital (electronic) documentation systems are known in the health care environment. Such systems are commonly called Electronic Health Records (EHR) or Electronic Medical Records (EMR) and are very broadly defined to include everything from the simple digital scan of a paper record to the database driven systems to which our preferred embodiment most pertains.

EHR systems have the potential to improve both the quality and the efficiency of provided health care, however current EHR systems are generally cumbersome to use and offer little assistance to the health care provider.

Despite the recognition that EHR systems are in many ways compelling, their use is still met with a certain degree of opposition, skepticism, and limited success. It is apparent that until providers are offered EHR systems that are easy to use and empower their ability to care for patients, such resistance will persist.

A barrier to ease of use and general usefulness of EHR systems is the difficulty of recording and integrating certain forms of data, such as the free-form text generally utilized to fully document a patient encounter. For free-form text entry, dictation and subsequent transcription by a trained transcriptionist (that is, a person who translates spoken words to written text) remains the easiest means of data capture from the health care provider's perspective. Most EHR systems expect providers to type their own free-text input or use a speech recognition software application to convert the dictation into text real-time. Therefore, although dictation is generally acknowledged as easy and time-efficient for the person dictating, integrated approaches to this preferable function are lacking.

Speech recognition software applications have varied degrees of accuracy depending on the user, the environment, and the application efficiency in detecting and interpreting the nuances of cadence, dialect, intonation, and complex language patterns. As a result, speech recognition dictation often requires significant editing of the text before it is finalized. Therefore, it often takes longer to dictate using a speech recognition software application than it does to dictate in a free-form manner to a human transcriptionist.

When providers use EHR systems that do not empower the provider to effectively use dictation and transcription as a method of recording patient data and where the provider still chooses to use this form of input, the EHR implementation often becomes contorted because of deficiencies of the system and the workarounds employed. The net effect is costly inefficiencies, failure prone workflows, documentation delay, compromised EHR system value, and other negative consequences.

Those EHR systems that accommodate dictation and transcription most often do so as an afterthought, employing cumbersome methods and generally limiting the incorporation of transcribed data to elements of the record that have little value in providing ongoing patient care. Because transcription is seldom incorporated into those portions of the record with recurring usefulness to the provider, the use of dictation and transcription as a means of input is penalized, forcing the provider to choose between easy input and future usefulness.

Prior to this invention, multiple approaches have been used to incorporate dictated input into an EHR depending on the features of the EHR system used. The two most common approaches include a transcriptionist typing directly into the EHR while listening to previously recorded dictation; and, the use of ‘markers’ to denote the location where transcription is to be inserted through a process that requires the provider to insert a ‘marker’ into the EHR and then verbally describe the identifying attributes of the ‘marker’ in the separately recorded dictation. The ‘marker’ is then referenced in the transcription to correlate the transcription to the desired insertion location in the EHR.

EHR systems which incorporate dictated and transcribed input in the EHR by utilizing the direct input method (where the transcriptionist is required to type directly in the EHR) can consume valuable EHR system capacity, network bandwidth, and create security vulnerabilities in the EHR; or be inefficient and unnecessarily tedious. By requiring the transcriptionist to work within the EHR, the transcriptionist must be logged onto the provider's computer network and into the EHR itself while transcribing. This consumes EHR system capacity and network bandwidth, exposes more personal information to the transcriptionist than preferable, and, if using technology enabling a remote connection to the network over the Internet, could possibly compromise the security of the network and EHR data. If the provider wishes to avoid these drawbacks (and if the direct input method is the only method of transcription input accommodated by the EHR), then the provider is forced to have transcription typed outside of the EHR and subsequently manually inserted into the EHR by a system user. This method is time consuming, requires multiple personnel, and is expensive due to the cost of ‘double handling’ of the text.

EHR systems which utilize the dictation ‘marker’ approach to incorporate dictated and transcribed input in the EHR are prone to error and generally frustrate the effort to provide accurate transcription. The approach is error prone because the ‘marker’ is not automatically linked to the dictation. Instead, the approach requires that the attributes of the ‘marker’ (typically a series of numbers or alpha characters or a combination of the two, for example “ABC123”) be associated with the transcription manually. The ‘marker’ must be accurately relayed as it is read from the EHR by the provider, dictated by the provider to the transcriptionist, heard by the transcriptionist in the dictation, and finally typed by the transcriptionist again as text. Any inaccuracy in this chain will cause the transcribed text to either be inserted into the EHR incorrectly (wrong place and perhaps wrong patient) or ‘orphaned’, requiring the provider or another system user to reconcile it. In addition, the ‘marker’ makes providing accurate transcription more difficult because the dictation is only contextualized to the EHR and within the EHR through the ‘marker’, which provides little if any contextualizing data (such as patient demographics, complaint, diagnosis, plan, etc.). Without context, dictation can be easily misunderstood and any opportunity for reconciling contradictory input is eliminated.

Regardless of the EHR system, dictation which is to be transcribed is recorded independently from the EHR through the use of various recording devices known in the art. These include phone-in recording systems, portable handheld recorders (both digital and analog tape type), and computer based recording devices (running on computer workstations, notebooks, tablet computers, or mobile devices). The recorded dictation is then transmitted to the transcriptionist by electronic processes where the recording is digital in format and by physical transport where the recording is an analog tape. Recorded dictation is contextualized to the EHR through manual processes, most of which provide very little information to assist the transcriptionist to accurately transcribe the dictation and to help EHR system users reconcile ‘orphaned’ transcription (that is transcribed text that does not correctly correlate to the EHR).

Contextualization of the recorded dictation when phone and handheld recorders are used is most commonly achieved when the dictating provider verbally references the EHR dictation ‘marker’ (as previously described) or identifying patient demographic information. When computer based recording devices are used the situation is most commonly the same as when the other methods of recording are used. In some cases, however, the computer based recorder allows the dictating provider to contextualize the recording through a recording interface by picking an item in a list (such as patient name). Regardless of recording method, no single system can be used to reconcile all dictated and transcribed text to the specific portions of the EHR for which the text is intended. Instead, at least two distinct and disjointed tracking systems are needed to monitor and manage the dictation, transcription, and EHR text import.

All of the contextualizing methods described and presently known in the art, offer little if any meaningful information to assist in the creation (typing) of transcription. Efforts toward accuracy by the individuals engaged in this work are significantly frustrated by a lack of contextual information, making the work harder and less valuable to the provider.

Therefore, given the value of free-form text in fully documenting significant elements of patient care, the provider's success in adopting and best utilizing EHR systems is hampered. The net effect of this is slower EHR adoption, steeper learning curves for providers who do adopt an EHR system, and in many cases reduced provider efficiency when using an EHR system.

Another barrier to the ease of use and general usefulness of EHR systems by health care providers is the absence of interactive, contextualized, and annotated presentations of health data over time or other controlling variables. This data customarily pertains to the behaviors (smoking, exercising, etc.), condition (weight, blood pressure, etc.), diagnoses, and care (procedures, medications, etc.) of the patient.

Historically in practice of medicine, the graphical presentation of data in charts (line graphs, bar charts, pie charts, etc.) and flow diagrams (medication flow sheets, problem lists, etc.) was done manually through labor intensive, difficult, and error prone processes. As a result graphical presentations were used sparingly and for narrowly defined ranges of health information, with little or no correlation provided to aspects of patient health and details of provided care which not represented by the information graphed. For example, line graphs denoting blood pressure over time seldom referenced blood pressure therapies. Together, these deficiencies effectively made the use of trended information by health care providers very limited as a practical matter.

Systems and methods for presenting and graphing information in EHR systems are known in the art. While many EHR systems provide graphing and flow diagrams, they tend to replicate the historical limitations described above. The current art of presenting information in EHR systems does not maximize the value of the correlated and finely parsed patient health data recorded in the EHR nor do they allow for the manipulation and annotation features that are possible by maintaining and accessing discrete data in a computerized software application. Also, they do not contextualize the information by correlating the presented data to key events that may be related to the data being trended or the current body of medical knowledge (by indicating normal ranges, etc.). Therefore the use of trended information by health care providers is still limited as a practical matter.

Given the presence of these limitations, providers and other system users are compelled to navigate through the EHR system in order to consider all data pertaining to the subject of their interest. For example, a thorough clinical assessment of a patient with cardiovascular disease may require the review and correlation of many different sets of data such as weight, personal habits, monitored symptoms, medications and medication dosages, test results, procedures, and diagnoses. Comparing data values over time and relative to each other and clinical or other events is particularly preferred in the proper assessment of the patient, yet this is very difficult to accomplish for the EHR system user. Therefore, EHR systems are harder to use and less useful than they could be.

### BRIEF DESCRIPTION OF THE DRAWINGS

The preferred and alternative embodiments of the present invention are described in detail below with reference to the following drawings:

FIG. 1 depicts a block diagram of a computer system interacting with a transcription support server embodiment of the invention;

FIG. 2 depicts a flow chart of the Contextual Voice Recorder system, loosely integrated or not integrated with the EHR system;

FIG. 3 depicts a flow chart of the Contextual Voice Recorder system, tightly integrated with the EHR system;

FIGS. 4, 5, 6, 7 and 8 depict embodiments of the Contextual Voice Recorder user interface: Condensed (FIG. 4 400), stretched (FIG. 5 410), and maximized (FIG. 6 420) views; FIGS. 7 and 8 depict the Recording Review screen (430) and the Recorder Settings screen (440), respectively;

FIG. 9 depicts an embodiment of a user interface of an EHR system showing tight integration with the Contextual Voice Recorder; an Interactive Medication Flow Sheet, and a medical trend graph;

FIGS. 10 and 11 depict an embodiment of the medical trend graph, both with (FIG. 10) and without (FIG. 11) the annotation of related medical data; and

FIGS. 12 and 13 depicts an embodiment of the medical trend graph, with more than one parameter being graphed, both with (FIG. 12) and without (FIG. 13) the annotation of related medical data.

### DETAILED DESCRIPTION OF THE PREFERRED EMBODIMENT

A system and method that enhances the context, interactivity, functionality, and efficiency for Electronic Health Record (EHR) system users when entering, recording, displaying, manipulating, and clinically using specific types of patient health data in the EHR.

One embodiment of the present invention provides a system and method for integrating the spoken input of information with an EHR system's application database by using a contextualized voice recorder. Preferably, the system and method digitally records the spoken information, automatically inserts a unique digital recording identifier (‘marker’) into a pertinent database field, and ultimately replaces the unique digital recording identifier with the corresponding transcribed text.

Another embodiment of the present invention provides a system and method within an EHR system that displays a record of patient health data giving the EHR user the ability to interactively trend, contextualize, analyze, manipulate, and annotate clinically relevant data in a graphically rich line chart view. In alternate embodiments, pie charts or other graphical displays may be used.

Another embodiment of the present invention provides a system and method within an EHR system that displays a record, preferably historical, of patient medications giving the EHR user the ability to interactively trend, contextualize, analyze, manipulate, and annotate clinically relevant data in a graphically rich chart view.

Another embodiment of the present invention provides a system and method within an EHR system that displays a record of patient behavior and conditions giving the EHR user the ability to interactively trend, contextualize, analyze, manipulate, and annotate clinically relevant data in a graphically rich chart view.

Another embodiment of the present invention provides a system and method within an EHR system that displays a record, preferably historical, of patient health problems giving the EHR user the ability to interactively trend, contextualize, analyze, manipulate, and annotate clinically relevant data in a graphically rich chart view.

Another embodiment of the present invention provides a system and method within an EHR system that interactively displays a historical record of patient diagnoses giving the EHR user the ability to trend, contextualize, analyze, manipulate, and annotate clinically relevant data in a graphically rich chart view.

All the above pertain to the practice of medicine and the clinical documentation tools and systems that support the delivery and management of care. More specifically, these inventions leverage the use of an EHR system, preferably includes a database application as the means of recording, storing, using, and communicating patient health information.

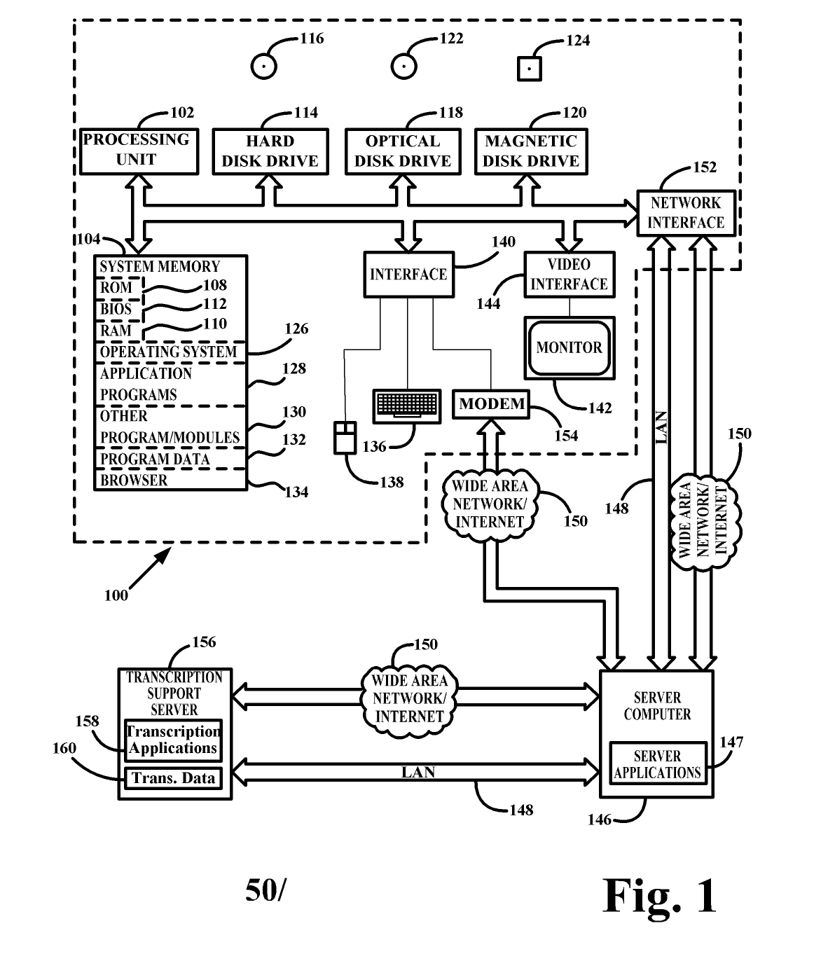

FIG. 1, describing an aspect of the electronic heath record system (EHR) 50 in cooperation with the following provides a general description of a computing environment that may be used to implement various aspects of the present invention. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, objects, and their equivalents may be located in both local and remote memory storage devices.

By way of example, a conventional workstation computer, referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc. Unless described otherwise, the construction and operation of the various blocks shown in FIG. 1 are of conventional design. As a result, such blocks need not be described in further detail herein, as they will be understood by those skilled in the relevant art.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122. The optical disk 122 can be a CD-ROM. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), USB memory sticks, etc.

Program modules can be stored in the system memory 104, such as an operating system 126, one or more application programs 128, other programs or modules 130 and program data 132. Although the depicted embodiment shows the computer 10 as a personal computer, in other embodiments, the computer is some other computer-related device such as a personal data assistant (PDA), a cell phone, or other mobile device.

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. A monitor 142 or other display device is coupled to the bus 106 via a video interface 144, such as a video adapter. The computer 100 can include other output devices, such as speakers, printers, etc.

The computer 100 can operate in a networked environment using logical connections to one or more remote computers, such as a server computer 146. The server computer 146 is an Electronic Health Record (EHR) Server hosting the EHR database. The server computer 146 can be connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 is configurable to run server applications 147, preferably including the EHR database server application.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are some examples of establishing communication links between computers, and other links may be used, including, but not limited to, wireless links.

The EHR server computer 146 is further communicatively linked to a transcription support system 156 typically through the LAN 148 or the WAN/Internet 150 or other networking configuration such as a direct asynchronous connection (not shown). Other embodiments may support the server computer 146 and the transcription support system 156 on one computer system by operating all server applications and transcription support system on the one computer system. The transcription support system 156 is configurable to run host applications 158, such as in system memory, and store host data 160 such as business related data.

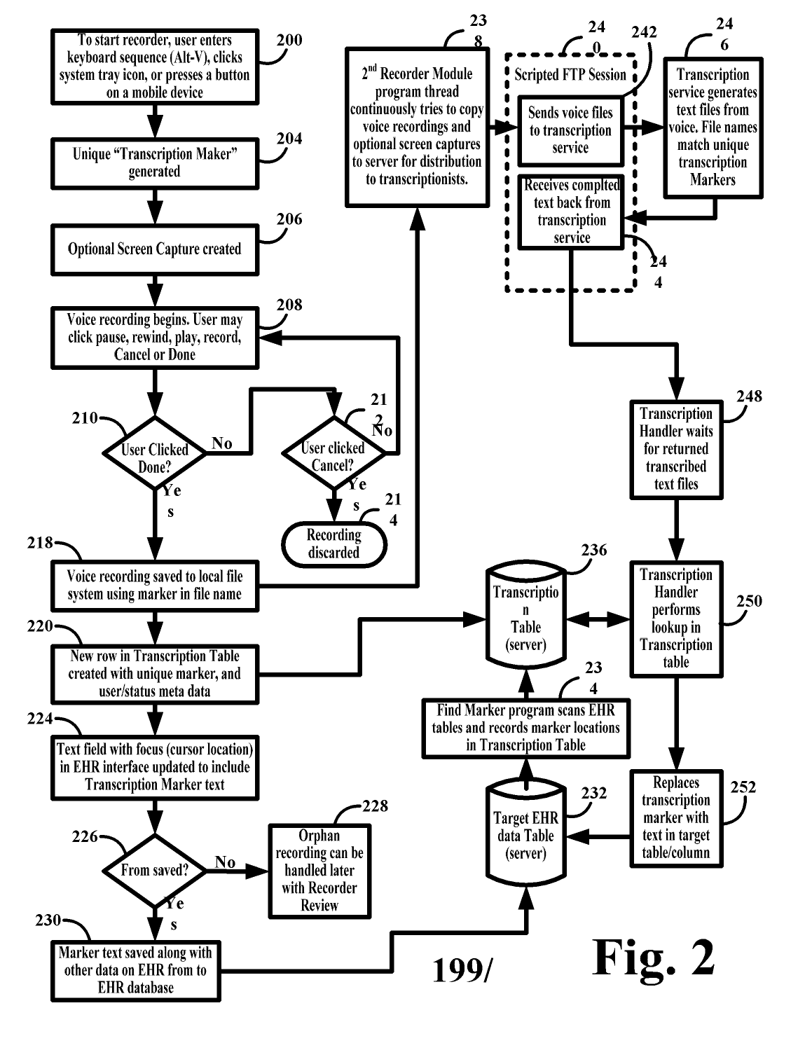

FIG. 2 is a flowchart illustrating a system 199 for correlating spoken information with a specified data element within a database application accessible through a user interface. As will be appreciated in the following description, FIG. 2 also exemplifies the processes performed by the machine-readable medium encoded with instructions to perform the system 199. The Contextualized Voice Recorder is shown, in this case loosely integrated with the EHR system 50 of FIG. 1 or other database application.

In general, the system 199 can be used with an EHR system 50 of FIG. 1, but the system 199 is not limited to use with any particular EHR system database application. The system hardware and software components are provided specifically to support an EHR system and the exchange of data with an internal or external transcription support server, as described in FIG. 1 156.

In general terms, a Contextualized Voice Recorder (CVR) facilitates the system user's ease of use of the EHR system 50. The recorder tool optionally allows the user to dictate the input of information, have the dictation automatically transmitted and converted to text outside the EHR environment (preferably and/or optionally through either manual transcription or a voice recognition software application), and have the transcribed text automatically inserted into the corresponding field in the database. The CVR provides all of the tracking and correlating of voice files and data fields automatically and without intervention on the part of the person dictating or other user. Specifically, there is no need for the user to verbally or otherwise describe the unique digital recording identifier (that is transcription ‘marker’) or the database field to which the dictated information pertains. The CVR can automatically accomplish both.

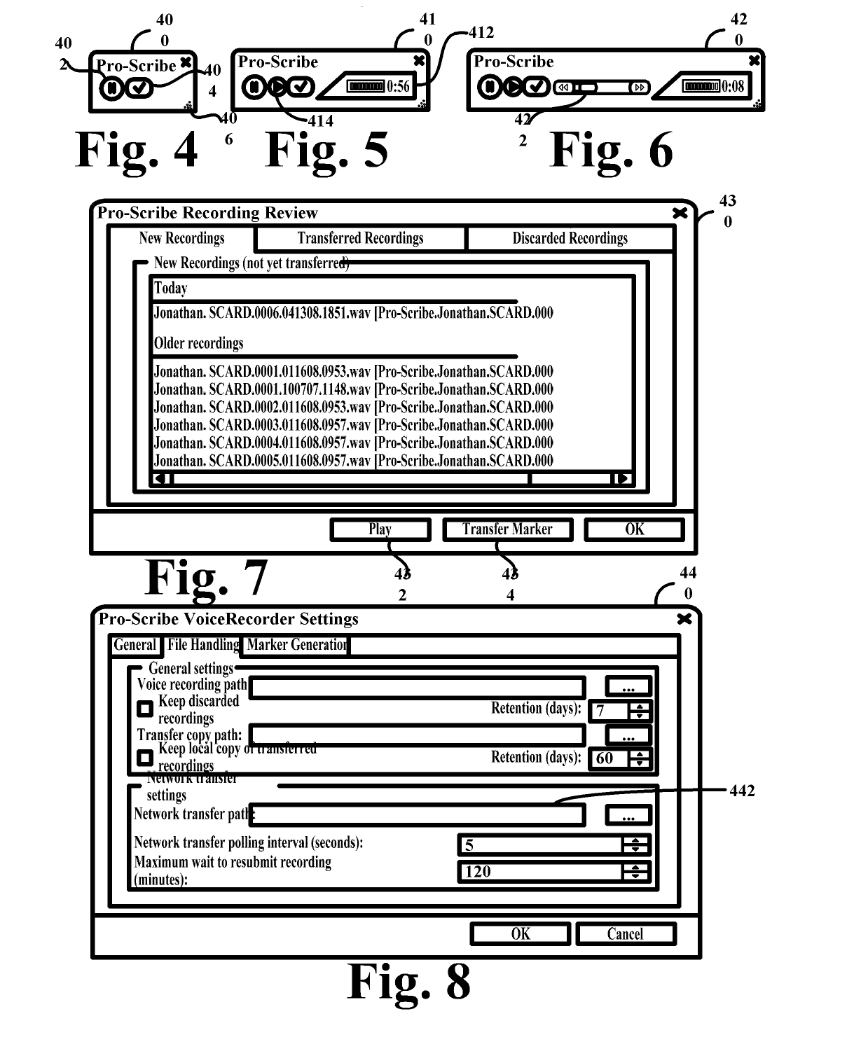

The CVR may be a software application, for example loaded onto a computer 100, that supports transcription or the use of a speech recognition software applications to convert speech to text in a process that works in association with a host application, but decoupled from it, wherein the user is able to enter text into free-form text fields (as opposed to drop down lists) and where the resulting data is stored in a database to which the CVR has read access. The CVR can run alongside any such host application but, in this non-limiting example, it is specifically designed for EHR system database applications. The CVR can be stand-alone (not integrated), loosely integrated, or tightly integrated with the host application or EHR system.

Where the CVR is not integrated (as described in one embodiment of FIG. 2) with the host application, the CVR program may be loaded by a Startup batch file, launched at the same time as the underlying host application, or by some other means such that it is already loaded when the user is ready to record dictation. Speech recording can be initiated using a predetermined keyboard sequence (hot key); combination of keys, such as <Alt>-P; by clicking on a CVR icon in the computer's system tray; or by pressing a preprogrammed button on mobile computing device. Preferably, in both the not-integrated and loosely integrated embodiments, the recorder controls reside in a separate window which floats over the host application. In the non-integrated embodiment, the CVR automatically places a unique recording identifier (a string of text constituting a “Transcription Marker” or “Marker”) at the location of the cursor in the host application that had temporal and/or spatial conceptual focus at the time the recording was started. In both the tightly and loosely integrated embodiments, the Transcription Marker may be placed in the input field associated with the microphone button, under host program control.

Where the CVR is loosely integrated (as described in an embodiment of FIG. 2) with the host application, buttons adjacent to form input fields in the host application launch the recorder, but the recorder controls reside in a separate window which floats over the host application (shown in FIG. 4 400, FIG. 5 410, and FIG. 6 420). The CVR program can be loaded by the host application 104 and/or EHR server computer 146.

Where the CVR is tightly integrated with the host application, microphone symbols 510, such as are illustrated in FIG. 9 are integrated into the host application form adjacent to form input fields which when selected launch the recorder and the controls of the recorder 506 (such as pause, rewind and complete). The CVR program can be loaded by the host application or EHR system 50.

The system user's computer workstation 100 or mobile computing device may be connected to a microphone through the computer's audio input interface.

FIG. 2 is a flowchart illustrating an embodiment for correlating spoken information with a specified data element within a database application accessible through a user interface. The CVR in this exemplary embodiment is loosely integrated with the EHR system 50 or other database application.

First, at Block 200, a workstation computer FIG. 1, is equipped with the recording software, a user enters a (hot key); combination of keys, such as <Alt>-P; by clicking on a CVR icon in the computer's system tray; or by pressing a preprogrammed button on a mobile computing device. At a Block 204 a unique identifier or “Transcription Marker” (FIG. 9 510) is automatically generated in an appropriate field, using parameters such as, for example only, the date and time, a client or location code, the user name and a optionally, a sequentially incrementing number. One or more of these parameters are set using a Setting's Interface as shown in FIG. 8. Referring back to FIG. 2, BLOCK 206, a screen capture (that is, digital image of the user's computer display) can be created to provide additional context for the transcriptionist. The resulting image file may be named using the same Transcription Marker as the base file name. The image file may accompany the digital voice recording file as it moves through the conversion process. Next, at a Block 208, while recording, the user can use pause, rewind, play and record using the interface components shown for example, in FIG. 4 “pause” 402 and “record” 404, FIG. 5 “play” 414, and FIG. 6 “rewind” 42.

The user has a choice after the recording session is done. At Block 210, if the user is “done” the voice recording is saved to a local file system at a Block 218 (FIG. 1 104) using the unique Transcription Marker in a new file name. Alternatively, if the user indicates “Cancel” at Block 212, the recording is discarded 214.

Next, at a Block 220, a new row is created in a Transcription Table at Block 236 containing the network user ID for the person recording the dictation, transcription marker, date, and time.

Next, at a Block 224, the unique transcription marker is inserted into the text field; the text field relates specifically the host application user interface, at the cursor location. If the application name of the window, as reported by the operating system (FIG. 1 126), does not match the list of predefined target applications, the user can be prompted to select the desired target input component.

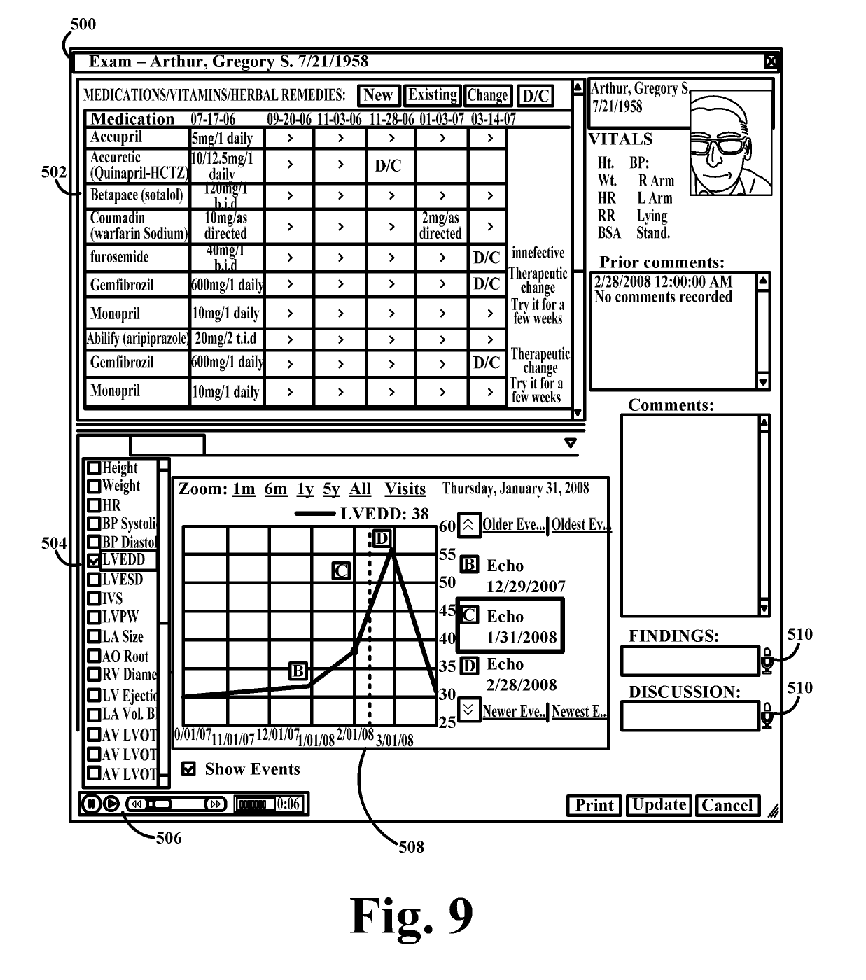

At a Block 226, a form, i.e., a user interface component of the EHR (e.g., a Patient Health History form, or a New Patient form or an Echocardiogram intake form), was previously saved, the unique transcription marker is also saved into the target application's database 230 and 232. If the form is not saved at Block 228 it may be considered an “orphan recording” and can be handled with recorder review. That is, a recording is saved for which there is no corresponding transcription marker in the target EHR database. Also, if, for example, the user cancels saving the form in the host application, an “orphan” recording is created. In this case, a Recording Review program can be used, with an interface Recording Review 430 as shown in FIG. 7. Once a recording has been identified by using Play button 432, the corresponding transcription marker can be transferred to the appropriate field in the host application by using the Transfer Marker button 434. Said marker may subsequently be identified by the Find Marker program, FIG. 2 Block 234, and processed properly.

A predefined list of all tables and columns in the target EHR database 232 is held on the EHR server computer 146. In one embodiment, available combinations of transcription markers are determined preferably by first identifying possible input fields in the host interface and then determining which tables and columns in the target EHR database 232 are used to store those values.

At a Block 234, on a regular schedule, a Find Marker program may scan a predefined list of tables and columns in the target EHR database of Block 232 looking for newly created transcription markers from the Transcription Table created at Block 236. Once found in the target EHR database of Block 232, the table, column, and row key can be saved in the corresponding row of the Transcription Table of Block 236. Once a row in the Transcription Table (of Block 236) has a target table, column and row key, that row will no longer be processed by the Find Marker program on subsequent runs.

In a non-limiting example, the Find Marker program can also flag documents containing the Transcription Marker as Pending Transcription or other designation as provided by features of the target EHR system.

At a Block 238, the audio file and optional screen capture can be transmitted automatically from temporary local storage files to the server for subsequent transmission to the transcriptionist for conversion. In a preferred embodiment, audio files can be stored on the server in a specified folder (see 442 on FIG. 8), where scripted SSL FTP sessions at Block 240 allow for these files to automatically and securely be sent at Block 242 over the internet to an independent transcription process at Block 246 at scheduled intervals.

At Block 246 a transcriptionist, for example, receives the recorded digital audio file and opens the recorded digital audio file, and accompanying screen capture image file, if any, with the transcription software, and converts the recorded audio file to a text file by manual transcription. The text file can be linked with the same unique identifier that identified the audio file. The manner in which the recorded audio file is converted to a text file with the same unique identifier can be, in another non-limiting embodiment, by utilization of voice recognition software.

Text returned by the transcription process Block 246 can be received back, again via secured email connection or scripted FTP session Block 244 to be processed by the Transcription Handler Block 248. The Transcription Handler can find the row associated with the transcription maker Block 250 by performing a query using the transcription marker with the Transcription Table at server Block 236. The results of this query can be a table, row and key value preferably required to find and replace the transcription marker text with the transcribed text in the database. A find-and-replace can then be performed, replacing the transcription marker with the transcribed text, while not modifying any other text that may also be saved in the same database location. In other words, the transcription marker may be prefixed or suffixed by existing text and the order and contents of said text can be preserved. If the transcription is successfully replaced in the database, the Transcription Table at Block 236 is updated with the date and time of the replacement.

In a non-limiting example, the Transcription Handler Block 250, when it replaces the transcription marker at a Block 252, can also update other tables in the target EHR database such that the document containing the newly inserted text is flagged for review by the originating user or flagged as Transcription Complete using the features of the target application.

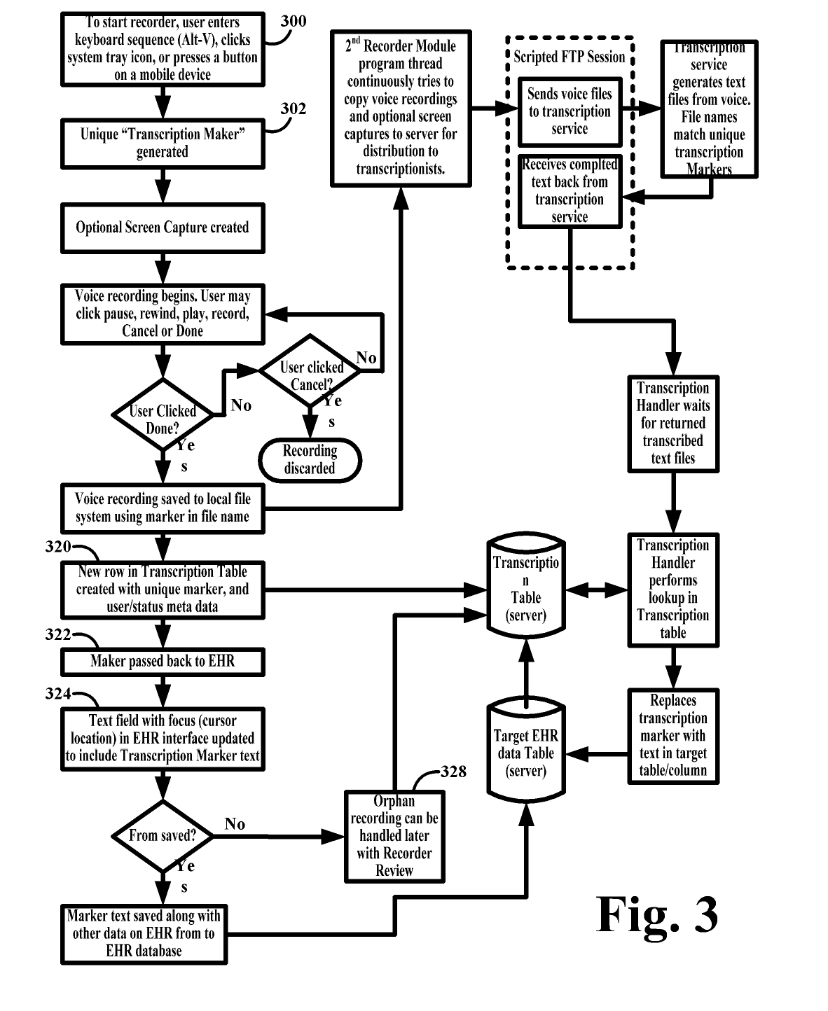

In an alternative embodiment, referring to FIG. 3, the user clicks a microphone button at a Block 300 in the user interface (also see FIG. 9 510) to initiate recording. A recorder module is passed to a target table, column and row key by the host EHR database at a Block 302. When a new row is created in the Transcription Table at Block 320, the target information, including the table, column and row key can be stored in the Transcription Table. In this configuration there is no need for a Find Maker program as described in FIG. 2, Block 234.

Referring to FIG. 4, one possible implementation of a CVR interface 400 is shown in the embodiments where it is loosely integrated or not integrated with the host database application. In this mode, the interface can optionally be as small as possible and is thus available in a condensed format 400. The user can stretch the window using the drag target 406 and the interface stretches to the moderately sized interface 410 illustrated in FIG. 5, which now includes a play button 414, as well as a Volume Unit (VU) meter and counter 412. When the interface is further stretched to the maximized format 420 illustrated in FIG. 6, the position indicator and slider 422 becomes visible.

In FIG. 3, at a Block 322, the Transcription Marker can be passed back to the host application and the host application can insert the transcription marker in an appropriate user interface element 324. This technique is generally preferred over relying upon which field has focus (cursor location). In other words, Block 324, where the text field is associated with the Microphone button in EHR interface, is updated to include transcription marker text, is generally preferred over Block 224, where the text filed with focus (cursor location) in EHR interface is updated to include transcription marker text.

If the form (see also discussion above at Block 226) in the target application is not saved, in order to avoid creating an “orphan” recording, the transcription module can be called at Block 328 to cancel the last recording.

In a non-limiting example, the original recording can be saved as a binary blob or fragment in the Transcription Table at Block 320 and be available for playback by clicking a link next to the transcribed text or by clicking the text itself in the user interface of the host application. This allows any user of the host application to verify proper conversion of speech to text.

User settings allow for audio files to be either completed and saved at the next change of computer operating system focus or simply paused and manually resumed.

In one embodiment of the invention, a medical trend graph allows the physician to analyze a large amount of historical and current patient data and correlate that data with care events such as the onset or cessation of disease, critical care incidents, medication start dates, medication stop dates, medication dosage change dates, visit dates and test dates. Displaying this information together is generally preferable, as it allows the care giver to discern or deduce correlations between trended data and discrete care events in ways that were not previously possible or required tedious study.

For example, as described in FIG. 11, changes in the occurrence and frequency of angina might precipitate a change in medication (“Warfarin started” 622 and 628). The physician can see multiple instances of angina as event flags superimposed on the graph of Diastolic blood-pressure over time, start a medication, and then verify that blood pressure did indeed begin to go down after that intervention.

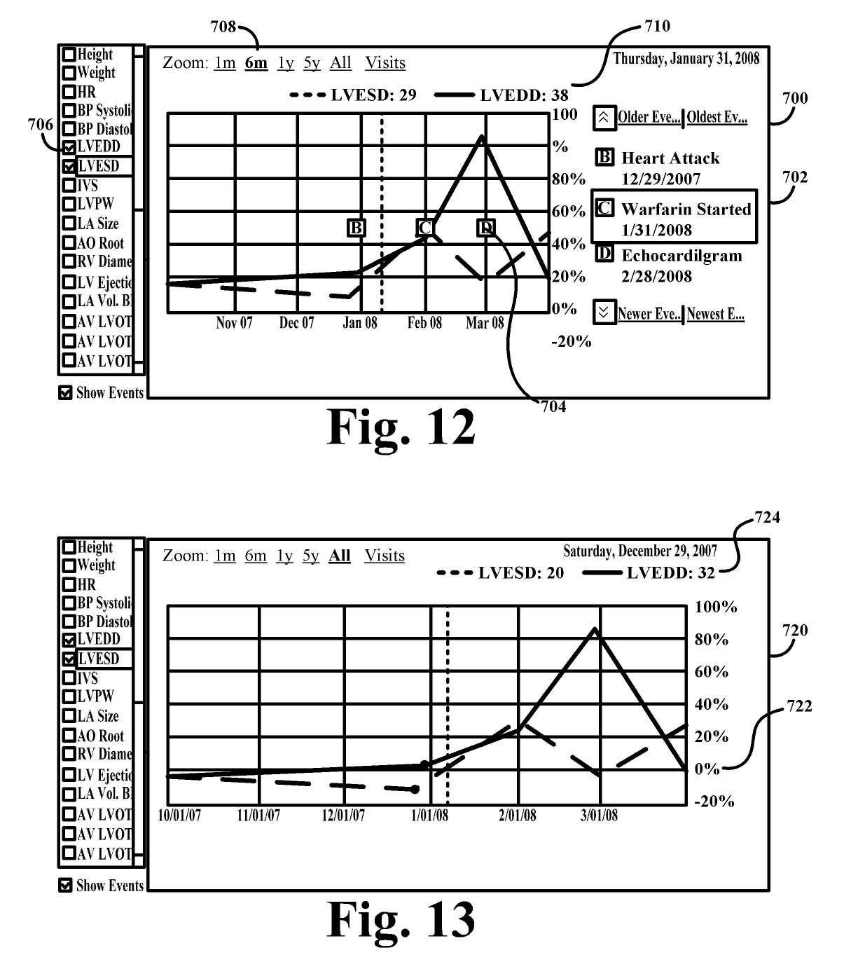

Turning to a graphical interface 700 depicted in FIG. 12, a physician may evaluate other data, for example a patient's Left Ventricular End Diastolic Diameter (LVEDD) (See figure legend 710), and this can be graphically charted over time, and integrated seamlessly with health care events 702 such as catastrophic illness (e.g., “B heart attack”), medications (e.g., “C. Warfarin started”) or an event relating to the patient's medical examination (e.g., “D. Echocardiogram”). Medical data 706 to be displayed on the medical trend graph is selected from the EHR database hosted on the server computer 146. The graphical interface 700, as illustrated in this example, can alert the physician to multiple variables he had not considered, for example, medical variables (e.g. blood pressure) and medical events (e.g., prescription changes, angina pain) can be automatically linked in a default setting. In this example, a medical trend graph may link display of LVEDD changes over time (e.g., for the last 6 months) with flagged events such as changes in prescription 702 (also FIG. 11 622) and occurrences of heart attack within that same time frame. In a default setting, certain logical parameters can be linked and presented to the physician automatically. The physician can easily see the flagged medical event as each occurrence is linked in time and related to the LVEDD 706, 710 graphic in the viewing window.

A graphic interface 500 as illustrated in FIG. 9 provides a powerful, and instantaneous visual queue of the events critical to the patient's long-term treatment plan affecting the parameter the physician is measuring. The data can be exportable at various points in the workflow, for example a printed copy of the treatment plan can be given to the patient's primary care physician for follow-up.

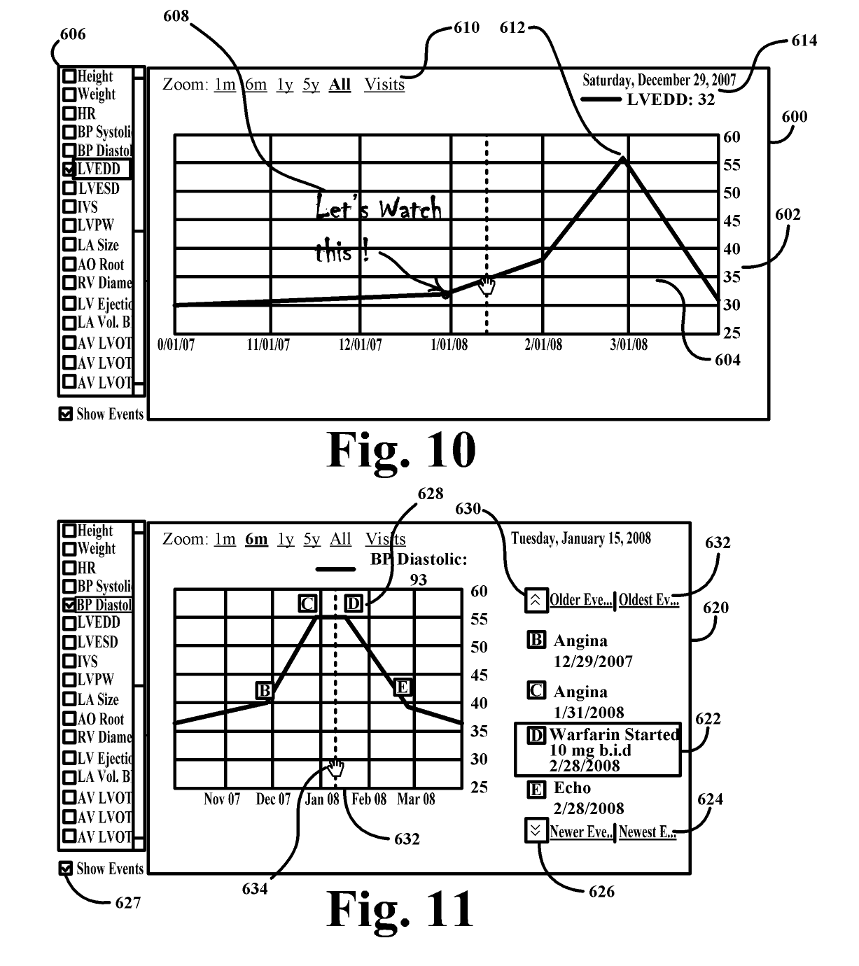

FIGS. 9-15 depict screenshots of exemplary EHR system application graphic interfaces 500, 600, 620, 700, 720 showing both tabulated data in a Patient Medication Flow Sheet 502 (also see FIGS. 14 and 15) and graphed data 504, 606, 627, 706 in medical trend graphs 508, 600, 620, 700, 720. The medical trend graph 508 of FIG. 9 (Also see FIG. 10 600 and FIG. 11 620) is further shown with (FIG. 11 622 and 628) and without (FIG. 10) integrated event/treatment flagging 628. As illustrated in FIG. 9 for example, the medical trend graph 508 displays identified data as selectable data fields 504 and graphically correlates data values to events, which are then summarily displayed in the graphic interface 500. The graphing application allows providers to easily evaluate elements of the patient's health (identified) data 504 by correlating those to time (e.g., in FIG. 11, time at a vertical reference line 635 a flagged event 622, 628 is with data element “BP diastolic”) and/or other identified data (e.g. FIG. 10 “LVEDD” 606) and/or clinical events 622 (See FIG. 11, where “show events” 627 is selected, selection scroll keys of older events 630, 633 and newer events 624, 626 are shown with listing of events “B”-“E” through a 6M time frame selected at the time period display 610) through the use of flags 628 embedded in the medical trend graph and linked to the clinical event 622 noted. For example, color-coded flags can indicate critical items for physician's immediate evaluation (e.g., event “D. Warfarin started”). For example, in FIG. 11, flags 628 (Also See FIG. 12 704) on the medical trend graph can be clicked on, and annotation associated with flagged event pops into a readable screen 622 (Also See FIG. 12 702). The viewing window can be adjusted, by selecting the time period display 610 which adjusted the user-selected medical events that are to be presented in the medical trend graph.

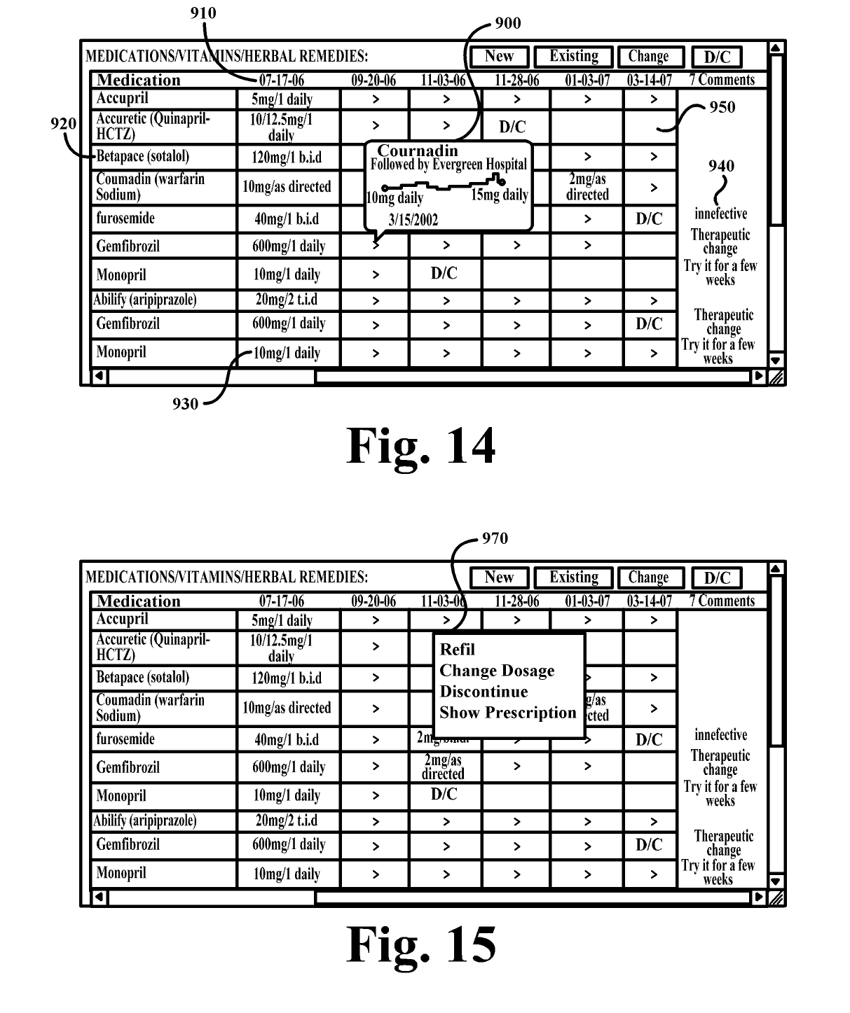

In one embodiment, such as depicted in FIGS. 10 and 11, if one data element is selected for inclusion in the graph, the vertical scale 602 of the medical trend graph is automatically adjusted to encompass the range of the data value over the time period represented. If multiple data elements are graphed (e.g., FIGS. 12 and 13) and referring to FIG. 13, the vertical scale 722 switches to percentage change, and all values start from a zero percentage point on the left of the graph. This allows values of different scales to be compared over time.

Referring to FIGS. 10, 11, 13 as a cursor 634 moves, colored dots 621 move on the graph, updating the corresponding value and date in a legend 614. Preferably, if multiple parameters are graphed, for example as is shown in FIGS. 12 and 13, values shown in the legends 710, 724 update and denote absolute rather than a percentage change, even though the vertical axis 722 of the graph shows percentages. The colored dots 621 can snap to the data point on the graph closest to the cursor 634. If multiple values are graphed, the dots 621 may not align vertically, as there might not be values for all of the data series on a particular date 704.

The vertical reference line 635 (shown in FIGS. 9-13) can follow the cursor 634 as it moves left and right to provide precise user feedback as to the cursor 634 location.

In FIG. 11, when event display 627 (compare to FIG. 10 and unchecked “show events” box) is enabled and one data element is graphed, the corresponding event flags can follow along the trace of the medical trend graph, for example, as with 628. If event display is enabled and multiple data series are graphed as in FIG. 12, the event flags can be displayed in a straight line across the middle of the graph.

In a non-limiting embodiment, when the cursor 634 is pressed and dragged on the medical trend graph, the entire medical trend graph shifts (pans) left or right along with the motion of the cursor. This is especially useful when the zoom (e.g., FIG. 12 708) is set to a level such as 1 m or 6 m. As the chart pans, if event display is enabled with Show Events 627 clicked, event flags appear and disappear from the graph while the event listing shifts, causing new events to appear and other events to disappear.

In another non-limiting embodiment shown in FIG. 11, the event list can be scrolled using the Scroll Up 630 and Scroll Down 626 buttons or the Older 633 or Newer 624 event links. Doing so will cause the main medical trend graph 620 to pan to ensure that the events shown in the event list also appear within the main area 632 of the medical trend graph 620.

Referring again to FIG. 11, selecting an event 622 in the event list will cause it to be highlighted, and also cause the corresponding event flag 628 on the graph to highlight.

Likewise, selecting the event flag 628 will cause it to be highlighted along with the corresponding event 622 in the event list.

As exemplified in FIG. 10, in one embodiment, the user interface 600 of the medical trend graph 600 can be a default list of medical data elements presented to the user as selectable data fields 606 as determined by patient problem and user role, wherein the user can select one or more medical data elements from the selectable data fields 606 presented as a default list to be charted and presented on a medical trend graph 600. The medical data elements as selectable data fields 606 and medical events (Shown in FIG. 11) which can be presented on the medical trend graph 600 can be data relating to, but not limited to, clinical visits, medical procedures, patient condition and vitals, allergies, medications, medication dosage changes, medication discontinuation, test results, utilized medical devices, symptom onset, symptom cessation, disease onset, or disease resolution.

In a non-limiting embodiment, the list of medical data elements as selectable data fields 606 (Also see FIG. 12 706) and the choice of which medical data elements are initially selected is determined by a database of medical data element 606 types (e.g., Blood Pressure, Cholesterol, LVEDD, etc.) and the clinical problems to which they are relevant (e.g., Coronary Artery Disease, Heart Murmur, etc.), filtered by the clinical problems experienced by the patient under care. In addition, the list may be modified by the user and any such modifications saved in a patient-specific table for future display. In this way, the medical trend graph will be immediately useful without undue setup time by the provider.

Turning to FIG. 11, in another non-limiting embodiment, when event display 627 is enabled, the events included in the event list are filtered by a database that correlates types of events and types of medications (e.g., “Warfarin Started” 622) with patient health problems (e.g., “B. Angina” and “C. Angina”) to which they are relevant, and filters the display based on the clinical problems experienced by the patient under care. The medical events section can provide a link to each of the related medical events in the EHR system 50. By clicking on the event listing 622, the full interface associated with the event will be presented. Related patient medical event links displayed in the patient medical events section are updated automatically, responsive to the user-adjustable viewing window being adjusted, so that patient medical event links corresponding to the time period selected 708 can be displayed. Furthermore as exemplified in FIG. 10, the medical trend graph 604 can be annotated with digital ink 608 that scrolls with the medical trend graph 604

Medical data elements can be presented to the user as selectable data fields 606 from which the user can select data element(s) for display on the medical trend graph. Selected medical data elements can be indicated by a check mark in the box adjacent to the data element in the list. Once selected, the relevant medical data can be extracted from the EHR system 50 database hosted on the server computer (FIG. 1 146) and displayed on the medical trend graph as depicted in FIGS. 9, 10, 11, 12, and 13.

Turning again to FIGS. 10 and 11, the user can select a time period of interest from the time period display 610 of the viewing window, thus the time period to be displayed on the medical trend graph will be adjusted for example to a 1 m, 6 m, 1 yr, or 5 period. The user can can limit the time period of interest over which to examine the medical data and/or select all, and/or select the medical data relevant to a particular visit. When one of the time periods in the list is selected, the corresponding period is displayed and the horizontal time scale 602 will be adjusted to match.

The EHR system 50 can display a line medical trend graph by passing a series of date-value pairs of data. The resulting medical trend graph (depicted in FIGS. 9, 10, 11, 12, and 13) automatically expands or contracts to fill the available area.

A series of date-event pairs can be passed from the EHR system database to the medical trend graph component with annotation letters 628 and 622 sequentially applied to the events. An option allows the event display to be in most recent first or most recent last order.

In one exemplary embodiment as shown in FIG. 10 colors can be automatically assigned to data series from a predefined list. The color appears on the medical trend graph line 612 and in the legend 614 to correlate the data series to the data element 606. A color can be assigned to each data series, and once assigned, that color is reserved for that series, such that if the series is removed from the medical trend graph and then later reapplied, it will appear in the original color.

Along with each data series submitted for graphing, the EHR application can present a range of values representing “normal” and/or “normal range” as understood by the current body of medical knowledge. These “normal” and/or “normal range” values can be displayed as horizontal bands of green and red 604 for normal and abnormal respectively.

The flow chart component of the invention visually presents the series of data stored in the EHR system database for a collection of similar data elements. Possible data element collections include but are not limited to, patient medications, patient health problems, and patient diagnoses.

The flow chart component allows providers to quickly analyze a large amount of data in an interactive form.

The patient medications collection of data elements can be presented in a Patient Medication Flow Sheet 502 as exemplified in FIGS. 9, 14, and 15. Other embodiments include a patient health problems collection of data elements that can be presented in a Patient Health Problems Flow Sheet and a patient diagnoses collection of data elements that can be presented in a Patient Diagnoses Flow Sheet.

All flow sheets can share common features. As an example, FIG. 14 shows a Patient Medication Flow Sheet. 502, medication data items 920 are listed and can be optionally sorted by medication class. Medication dosages 930 and the dates of clinical events 910 can be displayed in a matrix form. A column 940 can be reserved for provider comments. Medications that are listed, but have been discontinued, have blank item entries/backgrounds 950 post discontinuance.

In one non-limiting embodiment, when the cursor lingers (‘hovers’) on a row of the Patient Medication Flow Sheet 502, a “hover window” 900 with information about the medication under the cursor appears. This “hover window” 900 includes information about the medical data element presented in the row (e.g., “Coumadin” corresponded to row 4 in Patient Medication Flow Sheet 502). This information can include, but is not limited to, data element name, graphed value over time, date of first data in the series.

FIG. 15 is a screenshot depicting another exemplary interface of the Patient Medication Flow Sheet 502. When the user right-clicks on the row containing the data element, a menu of options 970 appears. These options relate specifically to the collection of data elements shown in the Patient Medication Flow Sheet 502. Selecting one of the options in the menu subsequently launches the EHR system's 50 component to execute the selected option.

While the particular embodiments of the invention have been illustrated and described, as noted above, many changes can be made without departing from the spirit and scope of the invention. For example, the number of interfaces specific to a particular practice can change, the data fields and the tabbed-category labels can change, the data entry and graphic display can change according to practice specialty, and the interfaces can be modified according to changes in industry and insurance standards. Also, the computer systems include at least one computer readable medium or memory for holding instructions programmed according to the teachings of the invention and for containing data structures, tables, records, or other data describe herein. Therefore examples of computer readable media are not constrained by an particular media choice, but include all computer readable media stored on any one or combinations of computer readable media used for controlling the computer systems of the embodiments of the disclosed invention, or for enabling the computer systems disclosed to interact with any human user (e.g. a remotely connect transcriptionist). Accordingly, the scope of the invention is not limited by the disclosure of the preferred embodiment. Instead, the invention should be determined entirely by reference to the claims that follow.

1. A system for correlating spoken information with a specified data field within a database application accessible through a user interface comprising:
a means for initiating speech recording and the creation of a digital audio file with a unique identifier;
a means for automatically inserting the unique identifier into any appropriate field in a user interface;
a means for transmitting the recorded audio file;
a means for converting the recorded audio file to a text file with the same unique identifier;
a means of receiving back the converted text file;
a means of replacing the unique identifier associated with the digital audio file in the appropriate field in the user interface with the contents of the corresponding text file.
a means of monitoring one or more of the unique identifiers, the digital audio files, and the converted text files.

2. The system for correlating spoken information of claim 1, wherein the means of automatically inserting the unique identifier into any appropriate user interface data field is by integrating a transcription marker into the user interface of the database application.

3. The system for correlating spoken information of claim 1, wherein the means of automatically inserting the unique identifier into any appropriate user interface data field is by monitoring a computer operating system focus at the time of transcription marker and inserting a transcription marker into an interface element containing the cursor.

4. The system for correlating spoken information of claim 1, wherein the means for converting the recorded audio file to a text file with the same unique identifier is by utilization of voice recognition software.

5. The system for correlating spoken information of claim 1, wherein the means for converting the recorded audio file to a text file with the same unique identifier is by transcription performed by a transcriptionist.

6. A machine-readable medium encoded with instructions, that when executed by one or more processors, cause the processor to carry out a process for providing the text of spoken medical information about a patient in an Electronic Health Record, the process comprising:
providing a display and controls (user interface) for initiating a speech recording and the creation of a digital audio file with a unique identifier;
providing automatic insertion of the unique identifier into any appropriate data field in a user interface;
transmitting the recorded audio file;
converting the recorded audio file to a text file with the same unique identifier;
receiving back the converted text file;
replacing the unique identifier associated with the digital audio file in the appropriate database field in the user interface with the contents of the corresponding text file.

7. The machine-readable medium of claim 6, wherein the automatic insertion of the unique identifier into any appropriate user interface data field is by integrating a transcription marker into the user interface of the database application.

8. The machine-readable medium of claim 6, wherein the automatic insertion of the unique identifier into any appropriate user interface data field is by monitoring a computer operating system focus at the time of transcription marker and inserting a transcription marker into an interface element containing the cursor.

9. The machine-readable medium of claim 6, wherein the conversion of the recorded audio file to a text file with the same unique identifier is by utilization of voice recognition software.

10. The machine-readable medium of claim 6, wherein the conversion of the recorded audio file to a text file with the same unique identifier is by transcription performed by a transcriptionist.

11. A user interface of a system for correlating spoken information with a specified data field and subsequently transcribed text within a database application, the user interface comprising:
a means for initiating speech recording and the creation of a digital audio file with a unique identifier;
a means for automatically inserting the unique identifier into any appropriate field in a user interface;
a means for transmitting the recorded audio file;
a means for converting the recorded audio file to a text file with the same unique identifier;
a means of receiving back the converted text file;
a means of replacing the unique identifier associated with the digital audio file in the appropriate field in the user interface with the contents of the corresponding text file.
a means of monitoring the unique identifiers, digital audio files, and converted text files so as to maintain the correlation throughout the workflow and provide a means of management.

12. The user interface of claim 11, wherein the means for inputting data relevant to data items and data fields is a voice recorder.

13. The user interface of claim 11, wherein the means for inputting data relevant to data items and data fields is by converting a recorded audio file to a text file by utilization of voice recognition software.

14. A system for providing medical information regarding a patient in response to a system user request, the system comprising:
a means for providing a chart for showing a medical graph of medical data over a time period;
a means for selecting the medical data to be displayed on the medical graph from the Electronic Health Record;
a means for providing a user-adjustable viewing window displayed on the medical graph;
a means for providing one or more medical event flags displayed on the medical graph of the medical chart, with each medical event flag anchored at a time period that corresponds to the occurrence of a medical event; and
means for providing a medical events section displayed concurrently with the medical chart graph, and for displaying a link to each of the medical events as recorded in the Electronic Health Record.

15. The system of claim 14, wherein related medical events links displayed in the medical event section are updated responsive to the user-adjustable viewing window being adjusted and updates in the Electronic Health Record, so that only medical event links corresponding to the relevant time period are displayed on the medical graph.

16. The system of claim 14, wherein medical event flags displayed on the graph of the chart represent medical events which are selected from the Electronic Health Record based on a pre-determined default relationship set by the user to link a medical event with the medical data to be concurrently displayed, wherein the medical data to be displayed on the medical chart graph is selected by user and represents medical data items extracted from the Electronic Health Record.

17. The system of claim 14, wherein the user-adjustable viewing window is configurable with navigation handles that enable a user to adjust viewing window size.

18. The system of claim 14, wherein the user-adjustable viewing window is configurable with navigation handles that enable a user to adjust viewing window position.

19. A machine-readable medium encoded with instructions, that when executed by one or more processors, cause the processor to carry out a process for providing medical information about a patient in response to a user request, the process comprising:
providing a chart for showing a medical graph of medical data over a time period;
providing a plurality of data links to medical data in the Electronic Health Record selectable by user to be displayed on the medical graph;
providing a user-adjustable viewing window displayed on the medical graph;
providing one or more medical event flags displayed on the medical graph of the medical chart, with each medical event flag anchored at a time period that corresponds to the occurrence of a medical event;
providing a medical events section displayed concurrently with the medical chart graph, and for displaying a link to each of the medical events as recorded in the Electronic Health Record.

20. The machine-readable medium of claim 20, wherein related medical events links displayed in the medical event section are updated responsive to the user-adjustable viewing window being adjusted and updates in the Electronic Health Record, so that only medical event links corresponding to the relevant time period are displayed on the medical graph.

21. The machine-readable medium of claim 20, wherein medical event flags displayed on the graph of the chart represent medical events that are selected from the Electronic Health Record based on a pre-determined default relationship set by the user to link a medical event with the medical data to be concurrently displayed, wherein the medical data to be displayed on the medical chart graph is selected by user and represents medical data items extracted from the Electronic Health Record;

22. A user interface of a system for providing medical information regarding a patient as part of an Electronic Health Record system, the user interface comprising:
a chart for showing a graph of medical data over a time period, wherein one or more series of numeric medical data elements are user-selectable for display on the graph, individually or in combination;
one or more event markers displayed on the graph, with each marker anchored at a time included in the time period that corresponds to a clinical event;
a capability for the system user to annotate the interface display with an ‘Ink’ application in free-hand; and
a user-adjustable viewing window.

23. The user interface of claim 23 further comprising:
a list of medical data presented to the user, wherein the user can select what medical data from the list is to be charted and presented on a medical graph; and
a plurality of user selectable markers selected from the default list of medical data, to be displayed as a flagged, annotatable points relative to the medical data presented on the medical graph.

24. The user interface of claim 23 wherein the medical data elements for display on the graph, individually or in combination are selected from the group including clinical visits, medical procedures, patient condition and vitals, allergies, medications, medication dosage changes, medication discontinuation, test results, utilized medical devices, symptom onset, symptom cessation, disease onset, or disease resolution.

25. The user interface of claim 23, wherein the means for graphically presenting data relevant to the medical data elements and the medical data fields to the user is an annotatable graphic display, wherein one or more series of numeric medical data elements are user-selectable, and are plotted individually or in combination over a time period.

26. The user interface of claim 23 wherein one or more medical event markers displayed on the graph are selected from the group including clinical visits, medical procedures, patient condition and vitals, allergies, medications, medication dosage changes, medication discontinuation, test results, utilized medical devices, symptom onset, symptom cessation, disease onset, or disease resolution

27. The user interface of claim 23 wherein the chart for showing a graph of medical data over a time period is annotated with digital ink that scrolls with the graph.

28. The user interface of claim 23 wherein the chart for showing a graph of medical data over a time period is annotated with voice recordings stored as a digital audio file, wherein the digital audio file is contextualized by placing a dictation marker on the graph.

29. The user interface of claim 23, further comprising a medical events section displayed concurrently with the medical chart, and for displaying a link to each of the related medical events in the Electronic Health Record.

30. The user interface of claim 23, wherein related patient medical event links displayed in the patient medical events section are updated responsive to the user-adjustable viewing window being adjusted, so that only patient medical event links corresponding to the time period are displayed.

31. The user interface of claim 23, wherein only patient medical event markers and links relating to the selected medical data series and corresponding to the user adjustable viewing window are displayed in the events section.

32. The user interface of claim 23, wherein the user-adjustable viewing window is configurable with navigation handles that enable a user to adjust viewing window size and position.

33. The user interface of claim 23, wherein the chart includes one or more pan controls that allow a user to adjust the time period.

34. The user interface of claim 23, wherein the chart includes one or more pan controls that allow a user to select time scale across the width of the graph.

35. The user interface of claim 30, wherein the chart includes one or more pan controls that allow a user adjust the viewing window of the graph to go forward and backward along the time axis.

36. The user interface of claim 30, wherein the user interface is incrementally updated with new medical data received in response to subsequent system user input into the Electronic Health Record.

37. A system that enhances the context, interactivity, functionality, and efficiency for Electronic Health Record (EHR) system users when entering, recording, displaying, manipulating, and clinically using specific types of patient health data in the EHR.
